(19) United States
(12) Patent Application Publication
(10) Pub. No.: US 2026/0217052 A1
(43) Pub. Date: Jul. 30, 2026

(54) CONTROLLABLE DIRECT LIQUID TOOL PEN

(71) Applicant: Jiangxi Yihuale Pen industry Co., LTD, Nanchang (CN)

(72) Inventor: Chunfeng Wang, Nanchang (CN)

(21) Appl. No.: 19/445,439

(22) Filed: Jan. 9, 2026

(30) Foreign Application Priority Data
Jan. 24, 2025 (CN) 202510115545.5

(51) Int. Cl. B43K 27/08; B43K 8/00

(52) U.S. Cl. CPC B43K 27/08; B43K 8/003

(57) ABSTRACT

A controllable direct liquid tool pen includes: a pen body, a fixed ring clamped on the pen body, two first through slots arranged on two sides of the fixed ring, two elastic blocks, one of which is fixedly connected to one of the two first through slots, and two second through slots arranged on the pen body into which the two elastic blocks may be inserted. The pen body is arranged with a squeezing mechanism for automatically discharging liquid. When the controllable direct liquid tool pen is used in different fields, different liquid materials can be poured into the pen body, and the liquid output volume can be controlled in real time according to actual conditions during use, ensuring the use effect, and making the adaptability of the tool pen greatly improved.

### CROSS-REFERENCE TO RELATED APPLICATION

This application claims priority of Chinese Patent Application No. 202510115545.5, filed on January 24, 2025, the entire contents of which are incorporated herein by reference.

### TECHNICAL FIELD

The present disclosure belongs to the field of multifunctional tool pens, and particularly, to a controllable direct liquid tool pen.

### BACKGROUND

Tool pens refer to pen products that combine traditional writing functions with special tool functions. They are usually designed to incorporate a variety of practical tools, such as markers, glue pens, eyeliner pens, foundation pens and nail polish pens. The direct liquid tool pen refers to a tool pen that directly supplies ink through its own ink storage chamber. By installing a water guide core in the pen, ink is adsorbed on the water guide core and continuously delivered to the pen head through the water guide core contacting the pen head.

In the existing technologies, the pen head of the direct liquid writing pen adopts a ball head, that is, the ball is installed at the tip of the pen head, and the ball rotates to bring out ink during writing to realize the writing function. Although this direct liquid writing pen cannot easily leak, break or light ink during writing, ensuring the continuity and clarity of writing, its function is relatively single. After the ink is filled in the pen body, it can only be used for writing and cannot be used in different working fields. It belongs to a disposable pen. Its inks and other material components can easily cause serious polluting damage to the environment, have high recycling costs and are difficult to recycle.

Therefore, new solutions need to be provided to solve this problem.

### SUMMARY

In view of the shortcomings of the existing technologies, a purpose of the present disclosure is to provide a controllable direct liquid tool pen, when the controllable direct liquid tool pen is used in different fields, different liquid materials can be poured into the pen body, and the liquid output volume can be controlled in real time according to actual conditions during use, ensuring the use effect, and making the adaptability of the tool pen greatly improved.

The above technical objectives of the present disclosure are achieved through the following technical solution: a controllable direct liquid tool pen includes: a pen body, a fixed ring clamped on the pen body, two first through slots arranged on two sides of the fixed ring, two elastic blocks, one of which is fixedly connected to one of the two first through slots, and two second through slots arranged on the pen body into which the two elastic blocks may be inserted. The pen body is arranged with a squeezing mechanism for automatically discharging liquid.

According to this solution, when used in conjunction with the squeezing mechanism, the elastic block can be pressed to squeeze the liquid inside the pen body. When large liquid output volume is needed, press vigorously, which greatly increases the applicability of the tool pen.

The squeezing mechanism includes a fixed block fixedly connected to an inner wall of the pen body, a threaded rod slidably connected to the fixed block, a rotating post threadedly connected to the threaded rod, a limit ring fixedly connected to the rotating post, and a limit cover slidably connected to the rotating post; the limit cover is threadedly connected to the pen body, the threaded rod is arranged with a sealing assembly for pushing liquid, and the pen body is arranged with a blocking assembly for preventing liquid leakage.

According to this solution, the rotating post is rotated such that the threaded rod drives the sealing assembly to move inside the pen body and push the poured liquid, and cooperate with the blocking assembly to eliminate air bubbles in the poured liquid as much as possible. The limit ring cooperates with the limit cover, and screwing the limit cover on the pen body can be used to limit the position of the rotating post, prevent the rotating post from idling and thus failing to drive the threaded rod, and ensure the use effect of the tool pen.

The sealing assembly includes a push block fixedly connected to the threaded rod at one end away from the limit cover, and a sealing ring fixedly connected to the threaded rod, an outer wall of the push block and an outer wall of the sealing ring are both in contact with the inner wall of the pen body, and the push block and the sealing ring are both elastically deformable.

According to this solution, the push block and the sealing ring are arranged, which can greatly improve the sealing effect and prevent the liquid from entering between the push block and the limit cover when pushing and squeezing the poured liquid, so that the liquid discharged is more stable.

The blocking assembly includes a first liquid outlet head threadedly connected to the pen body, a limit post detachably connected in the first liquid outlet head, and a blocking cover clamped on the limit post, a through hole is arranged on the blocking cover, a support frame is fixedly connected to the limit post at one end away from the pen body; and one end of a spring is fixedly connected to the support frame, and the other end of the spring is fixedly connected to a blocking ball for blocking the through hole.

According to this solution, the blocking ball blocks the through hole through spring pressure, to prevent the poured liquid from flowing out when the tool pen is not in use. When the elastic block is pressed, the poured liquid pushes the blocking ball, causing the spring to contract to discharge the liquid. When the pressing of the elastic block is completed, the elastic block is reset, and the spring also resets to drive the blocking ball to block the through hole. At this time, due to pressure, the sealing assembly automatically pushes the poured liquid, realizing automatic pushing, which greatly improves the practicality of the tool pen.

Further, middle of the spring is fixedly connected to a positioning ring.

According to this solution, the spring can be prevented from dislocating, resulting in the situation that the blocking ball cannot block the through hole.

Further, a positioning block is detachably connected to the rotating post at one end away from the first liquid outlet head, and a magnet is in the positioning block and fixedly connected to a top side of the positioning block.

According to this solution, the positioning block can be installed on the rotating post to make it easier to rotate the rotating post, and the tool pen can be stood on the workbench through the magnet, making the tool pen easier to handle, fill with liquid, and avoid loss.

Further, the pen body is capable of being threadedly connected to a second liquid outlet head, a third liquid outlet head, a fourth liquid outlet head or a fifth liquid outlet head, a plurality of protrusions are fixedly connected to the inner wall of the first liquid outlet head, the inner wall of the second liquid outlet head, the inner wall of the third liquid outlet head, the inner wall of the fourth liquid outlet head and the inner wall of the fifth liquid outlet head, and a groove into which the plurality of protrusions are inserted is arranged on the limit post.

According to this solution, after the tool pen is used in one field, the limit post in the first liquid outlet head can be taken out, the blocking cover clamped on the limit post can be removed, the blocking ball and spring can be cleaned, and the first liquid outlet head can be replaced with a second liquid outlet head, a third liquid outlet head, a fourth liquid outlet head or a fifth liquid outlet head according to the field of use, thereby improving the utilization rate of the tool pen.

Further, the first liquid outlet head, the second liquid outlet head, the third liquid outlet head, and the fourth liquid outlet head are each capable of being detachably connected to a pen cap.

According to this solution, the pen cap can prevent external dust from contaminating the first liquid outlet head, the second liquid outlet head, the third liquid outlet head and the fourth liquid outlet head, ensuring the use effect of the tool pen during the next use.

In summary, the present disclosure has the following beneficial effects: when applied in different fields, different liquid materials can be poured into the pen body, and the first liquid outlet head can be replaced with a second liquid outlet head, a third liquid outlet head, a fourth liquid outlet head or a fifth liquid outlet head according to different use scenarios. The liquid outlet volume can also be controlled in real time according to actual conditions during use to ensure the use effect, which greatly improves the adaptability of the tool pen. For example, the first liquid outlet head, the second liquid outlet head, the third liquid outlet head, the fourth liquid outlet head, and the fifth liquid outlet head can be used in the beauty industry, the medical industry, the industrial industry, the art industry, and the model industry according to different purposes.

### BRIEF DESCRIPTION OF THE DRAWINGS

FIG. 1 is a schematic structural diagram of a controllable direct liquid tool pen of the present disclosure.

FIG. 2 is a first sectional view of the controllable direct liquid tool pen of the present disclosure.

FIG. 3 is a second sectional view of the controllable direct liquid tool pen of the present disclosure.

FIG. 4 is a third sectional view of the controllable direct liquid tool pen of the present disclosure.

FIG. 5 is an exploded view of the controllable direct liquid tool pen of the present disclosure.

FIG. 6 is a schematic structural diagram of some components of part of the controllable direct liquid tool pen of the present disclosure.

Reference numerals and denotations thereof: 1-pen body; 2-fixed ring; 3-first through slot; 4-elastic block; 5-second through slot; 6-fixed block; 7-threaded rod; 8-rotating post; 9-limit ring; 10-limit cover; 11-push block; 12-sealing ring; 13-first liquid outlet head; 14-limit post; 15-blocking cover; 16-through hole; 17-support frame; 18-spring; 19-blocking ball; 20-positioning ring; 21-protrusion; 22-groove; 23-positioning block; 24-magnet; 25-second liquid outlet head; 26-third liquid outlet head; 27-fourth liquid outlet head; 28-fifth liquid outlet head; and 29-pen cap.

### DETAILED DESCRIPTION

The present disclosure is described in detail below with reference to the drawings and embodiments.

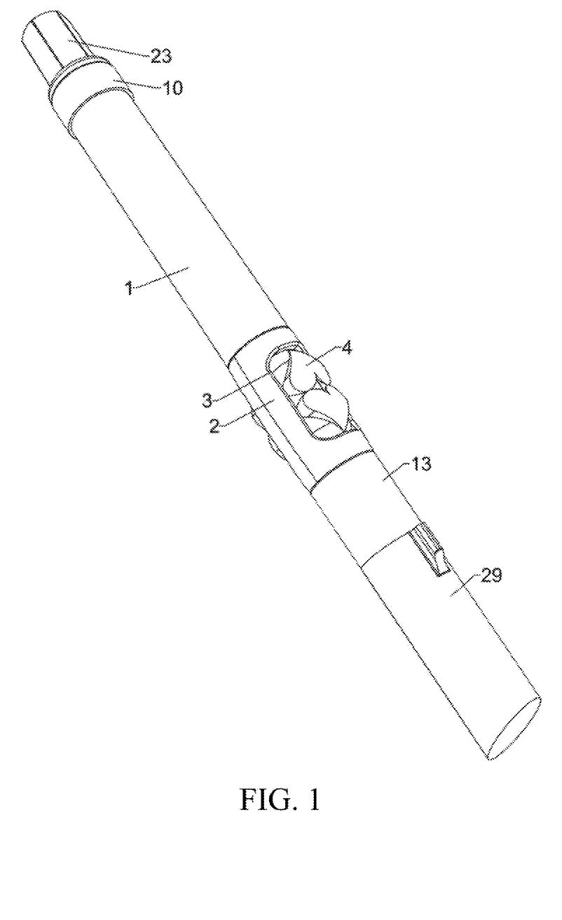

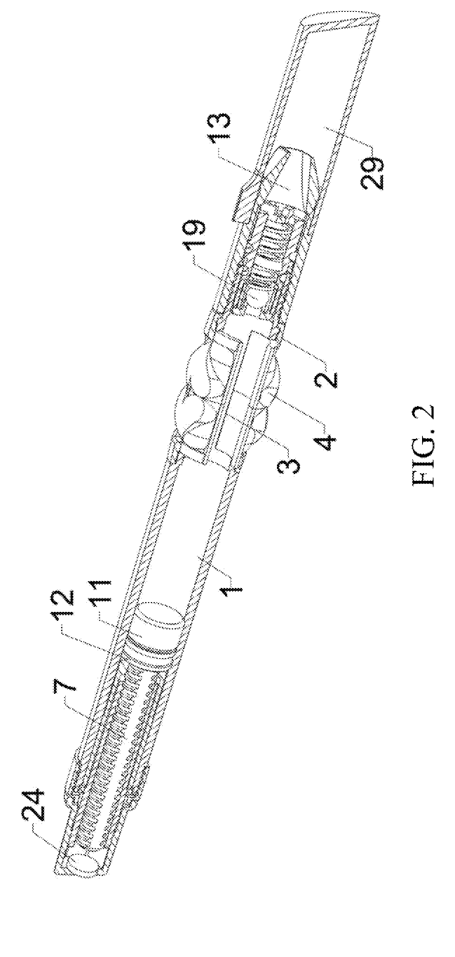

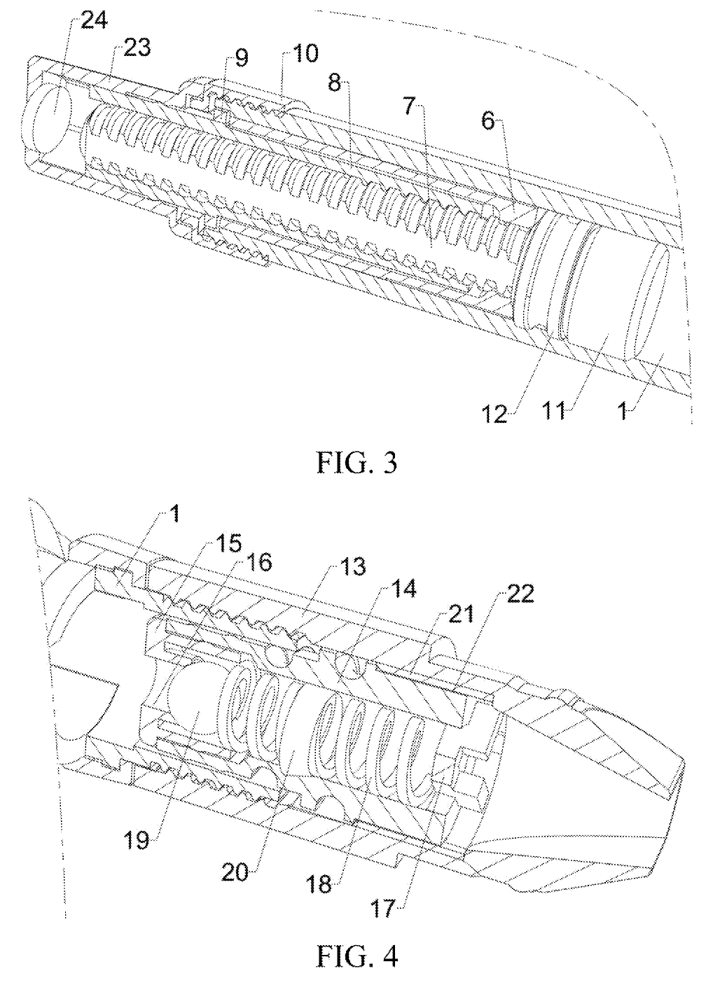

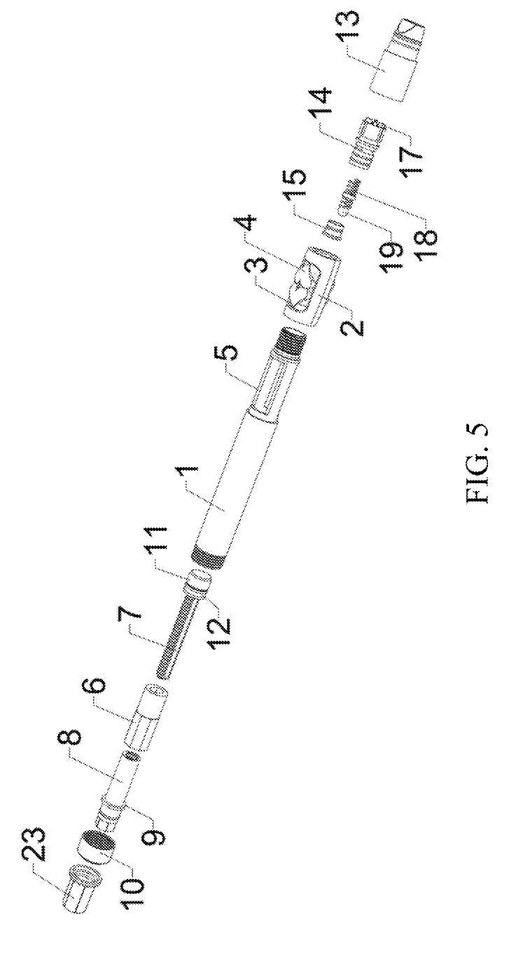

A controllable direct liquid tool pen, as shown in FIGS. 1-5, includes a pen body 1, a fixed ring 2 clamped on the pen body 1, two first through slots 3 arranged on two sides of the fixed ring 2, two elastic blocks 4, one of which is fixedly connected to one of the two first through slots 3, and two second through slots 5 arranged on the pen body 1 into which the two elastic blocks 4 can be inserted (one elastic block 4 inserted into one second through slot 5). The pen body 1 is arranged with a squeezing mechanism for automatically discharging liquid. The squeezing mechanism includes a fixed block 6 fixedly connected to an inner wall of the pen body 1, a threaded rod 7 slidably connected to the fixed block 6, a rotating post 8 threadedly connected to the threaded rod 7, a limit ring 9 fixedly connected to the rotating post 8, and a limit cover 10 slidably connected to the rotating post 8. The limit cover 10 is threadedly connected to the pen body 1, the threaded rod 7 is arranged with a sealing assembly for pushing liquid, and the pen body 1 is arranged with a blocking assembly for preventing liquid leakage. The sealing assembly includes a push block 11 fixedly connected to the threaded rod 7 at one end away from the limit cover 10, and a sealing ring 12 fixedly connected to the threaded rod 7. The outer wall of the push block 11 and the outer wall of the sealing ring 12 are both in contact with the inner wall of the pen body 1, and both the push block 11 and the sealing ring 12 have elastic deformation capabilities. The blocking assembly includes a first liquid outlet head 13 threadedly connected to the pen body 1, a limit post 14 detachably connected in the first liquid outlet head 13, and a blocking cover 15 clamped on the limit post 14. A through hole 16 is arranged on the blocking cover 15, a support frame 17 is fixedly connected to one end of the limit post 14 away from the pen body 1, one end of a spring 18 is fixedly connected to the support frame 17, and the other end of the spring 18 is fixedly connected to a blocking ball 19 for blocking the through hole 16.

As shown in FIGS. 1-5, before use, the rotating post 8 is rotated first. Since the rotating post 8 is blocked by the limit cover 10 at this time, the threaded rod 7 drives the push block 11 to move, so that the push block 11 and the sealing ring 12 are gradually move away from the first liquid outlet head 13 until the rotating post 8 cannot be rotated. The first liquid outlet head 13 is rotated to remove the first liquid outlet head 13, and then the required liquid is poured into the pen body 1. The first liquid outlet head 13 is installed on the pen body 1 and tightened, and then the rotating post 8 is rotated in the opposite direction, so that the push block 11 and the sealing ring 12 gradually approach the first liquid outlet head 13. At this time, the liquid in the pen body 1 is squeezed by the push block 11 and the sealing ring 12. When squeezed, the air bubbles in the liquid will be squeezed to burst. As the rotating post 8 continues to rotate, the liquid pushes against the blocking ball 19 and lifts up the blocking ball 19, so that the blocking ball 19 is no longer in contact with the blocking cover 15. At this time, the spring 18 is in a compressed state, and the liquid can also enter the first liquid outlet head 13, and the direct liquid tool pen can be used after the liquid is discharged from the first liquid outlet head 13.

As shown in FIGS. 1-5, when in use, the elastic blocks 4 are pressed according to the required liquid output volume, and the liquid in the pen body 1 pushes the blocking ball 19 and lifts the blocking ball 19 up, so that the blocking ball 19 no longer contacts the blocking cover 15. At this time, the spring 18 is in a compressed state and then liquid is discharged from the first liquid outlet head 13. After the liquid is discharged from the first liquid outlet head 13, the elastic blocks 4 are released, and the spring 18 is reset to drive the blocking ball 19 to block the through hole 16. At this time, due to pressure, the push block 11 and the sealing ring 12 move a certain distance towards the first liquid outlet head 13 to automatically push the liquid, so that when the elastic blocks 4 are pressed next time, the liquid can still be ensured to be normally discharged from the first liquid outlet head 13. When no liquid is discharged out by pressing the elastic blocks 4, the rotating post 8 can be rotated to cause the push block 11 and the sealing ring 12 to squeeze the liquid, to burst the air bubbles in the liquid, thus ensuring that the push block 11 and the sealing ring 12 can normally and automatically push the liquid.

As shown in FIG. 4, a positioning ring 20 is fixedly connected to the middle of the spring 18, which can prevent the spring 18 from dislocating and causing the blocking ball 19 to fail to block the through hole 16.

As shown in FIGS. 1, 2, 3 and 5, a positioning block 23 is detachably connected to the side of the rotating post 8 away from the first liquid outlet head 13, and a magnet 24 is in the positioning block 23 and fixedly connected to a top side of the positioning block 23. The positioning block 23 can be installed on the rotating post 8 to make it easier to rotate the rotating post 8, and the tool pen can be stood on the workbench through the magnet 24, making the tool pen easier to handle, fill with liquid, and avoid loss.

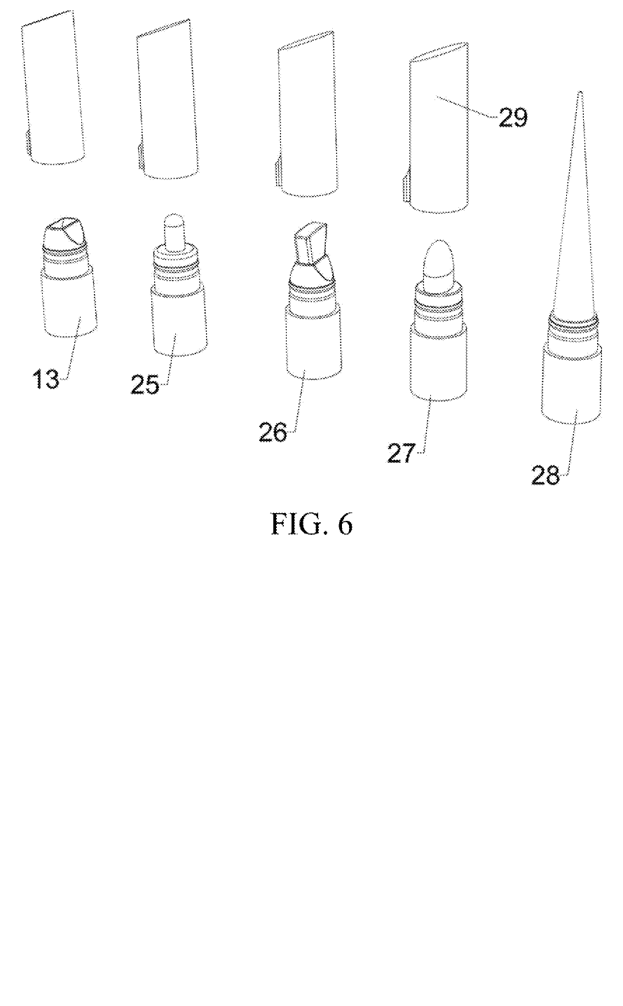

As shown in FIGS. 1, 2, 4 and 6, a second liquid outlet head 25, a third liquid outlet head 26, a fourth liquid outlet head 27 and a fifth liquid outlet head 28 are threadedly connected to the pen body 1. Multiple protrusions 21 are fixedly connected to the inner wall of the first liquid outlet head 13, the inner wall of the second liquid outlet head 25, the inner wall of the third liquid outlet head 26, the inner wall of the fourth liquid outlet head 27 and the inner wall of the fifth liquid outlet head 28. A groove 22 into which the multiple protrusions 21 are inserted is arranged on the limit post 14, and a pen cap 29 is detachably connected to the first liquid outlet head 13, the second liquid outlet head 25, the third liquid outlet head 26, or the fourth liquid outlet head 27. The pen cap 29 prevents external dust from contaminating the first liquid outlet head 13, the second liquid outlet head 25, the third liquid outlet head 26, and the fourth liquid outlet head 27, ensuring the use effect of the tool pen when it is used next time. The first liquid outlet head 13 can be installed to serve as a glue pen; the second liquid outlet head 25 can be installed to serve as a marker pen; the third liquid outlet head 26 can be installed to serve as a nail polish pen; the fourth liquid outlet head 27 can be installed to serve as a hazel-shaped brush; and the fifth liquid outlet head 28 can be installed to serve as an eyeliner pen, thereby improving the utilization rate of the tool pen. After using the tool pen in a certain field, the limit post 14 in the first liquid outlet head 13 can be taken out, the blocking cover 15 clamped on the limit post 14 can be removed, the blocking ball 19 and the spring 18 can be cleaned, and then the limit post 14 can be inserted into the second liquid outlet head 25, the third liquid outlet head 26, the fourth liquid outlet head 27 or the fifth liquid outlet head 28 according to the field of use. In this way, the utilization rate of the tool pen can be improved. For example, the first liquid outlet head 13, the second liquid outlet head 25, the third liquid outlet head 26, the fourth liquid outlet head 27, and the fifth liquid outlet head 28 can be used in the beauty industry, the medical industry, the industrial industry, the art industry, and the model industry according to different purposes.

Working principle: before use, the rotating post 8 is rotated first. Since the rotating post 8 is blocked by the limit cover 10 at this time, the threaded rod 7 drives the push block 11 to move, so that the push block 11 and the sealing ring 12 are gradually move away from the first liquid outlet head 13 until the rotating post 8 cannot be rotated. The first liquid outlet head 13 is rotated to remove the first liquid outlet head 13, and then the required liquid is poured into the pen body 1. The first liquid outlet head 13 is installed on the pen body 1 and tightened, and then the rotating post 8 is rotated in the opposite direction, so that the push block 11 and the sealing ring 12 gradually approach the first liquid outlet head 13. At this time, the liquid in the pen body 1 is squeezed by the push block 11 and the sealing ring 12. When squeezed, the air bubbles in the liquid will be squeezed to burst. As the rotating post 8 continues to rotate, the liquid pushes against the blocking ball 19 and lifts up the blocking ball 19, so that the blocking ball 19 is no longer in contact with the blocking cover 15. At this time, the spring 18 is in a compressed state, and the liquid can also enter the first liquid outlet head 13, and the direct liquid tool pen can be used after the liquid is discharged from the first liquid outlet head 13.

When in use, the elastic blocks 4 are pressed according to the required amount of liquid output, and the liquid in the pen body 1 pushes the blocking ball 19 and lifts the blocking ball 19 up, so that the blocking ball 19 no longer contacts the blocking cover 15. At this time, the spring 18 is in a compressed state and then liquid is discharged from the first liquid outlet head 13. After the liquid is discharged from the first liquid outlet head 13, the elastic blocks 4 are released, and the spring 18 is reset to drive the blocking ball 19 to block the through hole 16. At this time, due to pressure, the push block 11 and the sealing ring 12 move a certain distance towards the first liquid outlet head 13 to automatically push the liquid, so that when the elastic blocks 4 are pressed next time, the liquid can still be ensured to be normally discharged from the first liquid outlet head 13.

In this way, when applied in different fields, different liquid materials can be poured into the pen body 1, and the first liquid outlet head 13, the second liquid outlet head 25, the third liquid outlet head 26, the fourth liquid outlet head 27 or the fifth liquid outlet head 28 can be replaced according to different use scenarios. The liquid output volume can also be controlled in real time according to actual conditions during use, ensuring the use effect, and greatly improving the adaptability of the tool pen. For example, the first liquid outlet head 13, the second liquid outlet head 25, the third liquid outlet head 26, the fourth liquid outlet head 27, and the fifth liquid outlet head 28 can be used in the beauty industry, the medical industry, the industrial industry, the art industry, and the model industry according to different purposes.

The above are only preferred embodiments of the present disclosure, and the scope of protection of the present disclosure is not limited to the above embodiments. All technical solutions under the concept of the present disclosure fall within the scope of protection of the present disclosure. It is pointed out that for those skilled in the art, several improvements and refinements without departing from the principles of the present disclosure are also regarded as the scope of protection of the present disclosure.

1. A controllable direct liquid tool pen, comprising:
a pen body,
a fixed ring clamped on the pen body,
two first through slots arranged on two sides of the fixed ring,
two elastic blocks, one of which is fixedly connected to one of the two first through slots, and
two second through slots arranged on the pen body into which the two elastic blocks may be inserted, wherein
the pen body is arranged with a squeezing mechanism for automatically discharging liquid, the squeezing mechanism comprises a fixed block fixedly connected to an inner wall of the pen body, a threaded rod slidably connected to the fixed block, a rotating post threadedly connected to the threaded rod, a limit ring fixedly connected to the rotating post, and a limit cover slidably connected to the rotating post; and the limit cover is threadedly connected to the pen body, the threaded rod is arranged with a sealing assembly for pushing liquid, and the pen body is arranged with a blocking assembly for preventing liquid leakage;
the sealing assembly comprises a push block fixedly connected to the threaded rod at one end away from the limit cover, and a sealing ring fixedly connected to the threaded rod, an outer wall of the push block and an outer wall of the sealing ring are in contact with the inner wall of the pen body, and the push block and the sealing ring are both elastically deformable; and
the blocking assembly comprises a first liquid outlet head threadedly connected to the pen body, a limit post detachably connected in the first liquid outlet head, and a blocking cover clamped on the limit post, a through hole is arranged on the blocking cover, and a support frame is fixedly connected to the limit post at one end away from the pen body; and one end of a spring is fixedly connected to the support frame, and the other end of the spring is fixedly connected to a blocking ball for blocking the through hole.

2. The controllable direct liquid tool pen of claim 1, wherein middle of the spring is fixedly connected to a positioning ring.

3. The controllable direct liquid tool pen of claim 1, wherein a positioning block is detachably connected to the rotating post at one end away from the first liquid outlet head, and a magnet is in the positioning block and fixedly connected to a top side of the positioning block.

4. The controllable direct liquid tool pen of claim 1, wherein the pen body is capable of being threadedly connected to a second liquid outlet head, a third liquid outlet head, a fourth liquid outlet head or a fifth liquid outlet head, a plurality of protrusions are fixedly connected to an inner wall of the first liquid outlet head, an inner wall of the second liquid outlet head, an inner wall of the third liquid outlet head, an inner wall of the fourth liquid outlet head and an inner wall of the fifth liquid outlet head, and a groove into which the plurality of protrusions are inserted is arranged on the limit post.

5. The controllable direct liquid tool pen of claim 1, wherein the first liquid outlet head, the second liquid outlet head, the third liquid outlet head, and the fourth liquid outlet head are each capable of being detachably connected to a pen cap.
